(19) United States
(12) Patent Application Publication
(10) Pub. No.: US 2014/0125568 A1
(43) Pub. Date: May 8, 2014

(54) DISPLAY APPARATUS

(71) Applicant: Innolux Corporation, Miao-Li County (TW)

(72) Inventors: Bo-Chin Tsuei, Miao-Li County (TW); Mao-Nan Lee, Miao-Li County (TW); Tung-Lin Liu, Miao-Li County (TW); Yao-Lien Hsieh, Miao-Li County (TW); Jian-Cheng Chen, Miao-Li County (TW)

(73) Assignee: Innolux Corporation, Miao-Li County (TW)

(21) Appl. No.: 14/065,471

(22) Filed: Oct. 29, 2013

(30) Foreign Application Priority Data
Nov. 6, 2012 (TW) 101141133

(51) Int. Cl. G09G 3/36

(52) U.S. Cl. CPC G09G 3/36
USPC 345/87

(57) ABSTRACT

A display apparatus includes a liquid crystal display (LCD) panel, a source driver, a gate driver and a timing controller. The LCD panel includes a main scan line, a sub scan line, a first pixel and a second pixel. The timing controller controls the gate driver to alternately output a main scan signal and a sub scan signal within every frame time. A time difference between the main scan signal and adjacent the sub scan signal is a delay time value. The main scan signal controls the first pixel to be written with a first polarity data and the second pixel to be written with a second polarity data. The frame times include at least two different delay time values.

This application claims the benefit of Taiwan application Serial No. 101141133, filed Nov. 6, 2012, the subject matter of which is incorporated herein by reference.

### BACKGROUND OF THE INVENTION

1. Field of the Invention

The invention relates to a display apparatus.

2. Description of the Related Art

FIG. 11 shows a partial schematic diagram of a conventional liquid crystal display (LCD) panel and associated pixel data. FIG. 12 shows a schematic diagram of a single linear residual image generated in a conventional LCD panel. Referring to FIGS. 11 and 12, an LCD panel 21 includes a first polarity data line 211, a second polarity data line 212, main scan lines 213, sub scan lines 214, and pixels 215(11) to 215(16). The pixels 215(11) to 215(16) are respectively located at 11^{th} to 16^{th} rows of the LCD panel 21. The pixels 215(11), 215(13) and 215(15) are coupled to the first polarity data line 211, the main scan lines 213 and the sub scan lines 214; the pixels 215(12), 215(14) and 215(16) are coupled to the second polarity data line 212, the main scan lines 213 and the sub scan lines 214. A first polarity data D+ on the first polarity data line 211 is greater than or equal to a common voltage Vcom; a second polarity data D− on the second polarity data line 212 is smaller than or equal to the common voltage Vcom.

When the first polarity data D+ written to the pixel 215(14) is different from the first polarity data D+ written the pixel 215(12), and the second polarity data D− written to the pixel 215(13) is the same as the second polarity data D− written to the pixel 215(11), a noise voltage is generated. While the first polarity data D+ and the second polarity data D− are respectively written to the pixels 215(13) and 215(14), other pixels may be activated as being controlled by the sub scan lines 214, such that the noise voltage becomes written into other pixels. Hence, a linear residual image 210 is displayed on the LCD panel 21, as shown in FIG. 12.

### SUMMARY OF THE INVENTION

The invention is directed to a display apparatus.

According to an aspect of the present invention, a display apparatus is provided. The display apparatus includes an LCD panel, a source driver, a gate driver and a timing controller. The LCD panel includes a first polarity data line, a second polarity data line, a main scan line, a sub scan line, a first pixel and a second pixel. The first pixel is coupled to the first polarity data line, the main scan line and the sub scan line. The second pixel is coupled to the second polarity data line, the main scan line and the sub scan line. The source driver outputs a first polarity data to the first polarity data line, and a second polarity data to the second polarity data line. The gate driver is coupled to the main scan line and the sub scan line. The timing controller controls the gate driver to alternatively output a main scan signal and a sub scan signal in every frame time. A time difference between the main scan signal and adjacent the sub scan signal is a delay time value. The main scan signal controls the first pixel to be written with the first polarity data and the second pixel to be written with the second polarity data.

According to another aspect of the present invention, a display apparatus is provided. The display apparatus includes an LCD panel, a source driver, a gate driver and a timing controller. The LCD panel includes a first polarity data line, a second polarity data line, a main scan line, a sub scan line, a first pixel and a second pixel. The first pixel is coupled to the first polarity data line, the main scan line and the sub scan line. The second pixel is coupled to the second polarity data line, the main scan line and the sub scan line. The source driver outputs a first polarity data to the first polarity data line, and a second polarity data to the second polarity data line. The gate driver is coupled to the main scan line and the sub scan line. The timing controller controls the gate driver to alternatively output a main scan signal and a sub scan signal in every frame time. A time difference between the main scan signal and adjacent the sub scan signal is a delay time value. The main scan signal controls the first pixel to be written with the first polarity data and the second pixel to be written with the second polarity data. A period that the sub scan signal enables the sub scan line is greater than a period that the main scan signal enables the main scan line.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of a display apparatus according to a first embodiment of the present invention.

FIG. 2 is a partial schematic diagram of a display apparatus according to a first embodiment of the present invention.

FIG. 3 is a signal timing diagram of a main scan signal and a sub scan signal in different frame times according to a first embodiment of the present invention.

FIG. 4 is a schematic diagram of dividing brightness of a single linear residual into four linear residual images according to a first embodiment of the present invention.

FIG. 5 is a schematic diagram of a transmittance change after applying a voltage to liquid crystals.

FIG. 6 is a schematic diagram of a liquid crystal delay time T1, a stable time T2 and a rising time T3 for different voltage change intervals.

FIG. 7 is a signal timing diagram of a main scan signal and a sub scan signal in different frame times according to a second embodiment of the present invention.

FIG. 8 is a signal timing diagram of a main scan signal and a sub scan signal in different frame times according to a third embodiment of the present invention.

FIG. 9 is a signal timing diagram of a main scan signal and a sub scan signal in different frame times according to a fourth embodiment of the present invention.

FIG. 10 is a signal timing diagram of a main scan signal and a sub scan signal in different frame times according to a fifth embodiment of the present invention.

FIG. 11 is a partial schematic diagram of a conventional LCD panel and associated pixel data.

FIG. 12 is a schematic diagram of a single linear residual image generated in a conventional LCD panel.

### DETAILED DESCRIPTION OF THE INVENTION

### First Embodiment

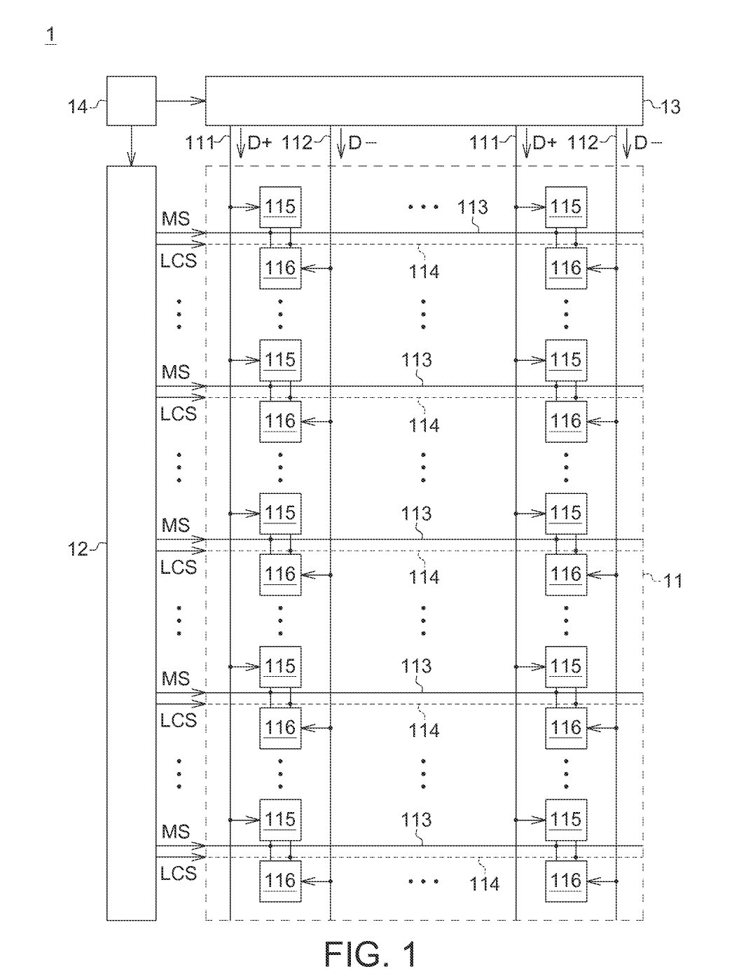

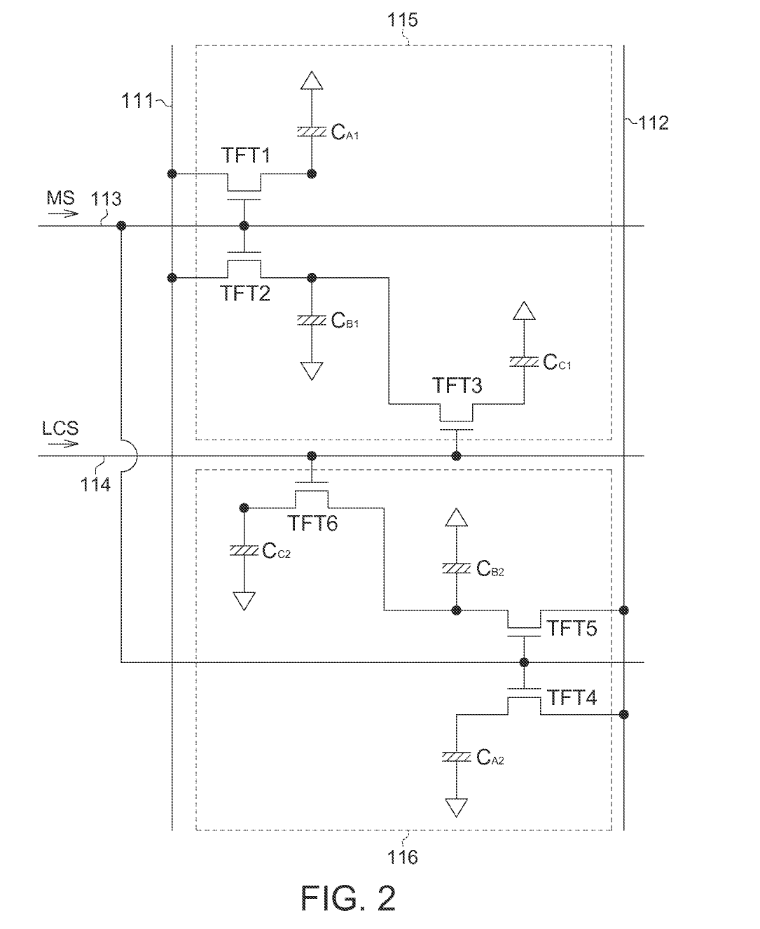

FIG. 1 shows a schematic diagram of a display apparatus according to a first embodiment of the present invention. FIG. 2 shows a partial schematic diagram of a display panel according to the first embodiment of the present invention. Referring to FIGS. 1 and 2, a display apparatus 1 includes a liquid crystal display (LCD) panel 11, a gate driver 12, a source driver 13 and a timing controller 14. The timing controller 14 controls the gate driver 12 and the source driver 13 to drive the LCD panel 11.

The LCD panel 11 includes first polarity data lines 111, second polarity data lines 112, main scan lines 113, sub scan lines 114, first pixels 115 and second pixels 116. The first pixels 115 are coupled to the first polarity data lines 111, the main scan lines 113 and the sub scan lines 114. The second pixels 116 are coupled to the second polarity data lines 112, the main scan lines 113 and the sub scan lines 114. The gate driver 12 is coupled to the main scan lines 113 and the sub scan lines 114. The source driver 13, coupled to the first polarity data line 111 and the second polarity data line 112, outputs first polarity data D+ to the first polarity data lines 111 and second polarity data D− to the second polarity data lines 112.

Referring to FIG. 2, each first pixel 115 includes a first liquid crystal capacitor C_{A1}, a first transistor TFT1, a second liquid crystal capacitor C_{B1}, a second transistor TFT2 and a first dark-area capacitor C_{C1}. The first transistor TFT1 is controlled by a main scan signal MS to electrically connect the first polarity data line 111 to the first liquid crystal capacitor C_{A1}. The second transistor TFT2 is controlled by the main scan signal MS to electrically connect the first polarity data line 111 to the second liquid crystal capacitor C_{B1}. The third transistor TFT3 is controlled by a sub scan signal LCS to electrically connect the first dark-area capacitor C_{C1} to the second liquid crystal capacitor C_{B1} to perform a charge distribution.

Also referring to FIG. 2, each second pixel 116 includes a third liquid crystal capacitor C_{A2}, a fourth transistor TFT4, a fourth liquid crystal capacitor C_{B2}, a fifth transistor TFT5, a second dark-area capacitor C_{C2} and a sixth transistor TFT6. The fourth transistor FTF4 is controlled by the main scan signal MS to electrically connect the second polarity data line 112 to the third liquid crystal capacitor C_{A2}. The fifth transistor TFT5 is controlled by the main scan signal MS to electrically the second polarity data line 112 to the fourth liquid crystal capacitor C_{B2}. The sixth transistor TFT6 is controlled by the sub scan signal LCS to electrically connect the second dark-area capacitor C_{C2} to the fourth liquid crystal capacitor C_{B2} to perform a charge distribution.

The timing controller 14 controls the gate driver 12 to alternately output the main scan signal MS and the sub scan signal LCS in every frame time. A time difference between the main scan signal MS and adjacent the sub scan signal LCS is a delay time value. The main scan signal MS controls the first pixel 114 to write the first polarity data D+ to the first liquid crystal capacitor C_{A1} and the second liquid crystal capacitor C_{B1}, and controls the second pixel 116 to write the second polarity data D− to the third liquid crystal capacitor C_{A2} and the fourth liquid crystal capacitor C_{B2}. The sub scan signal LCS controls the first pixel 115 and the second pixel 116 to perform a charge distribution.

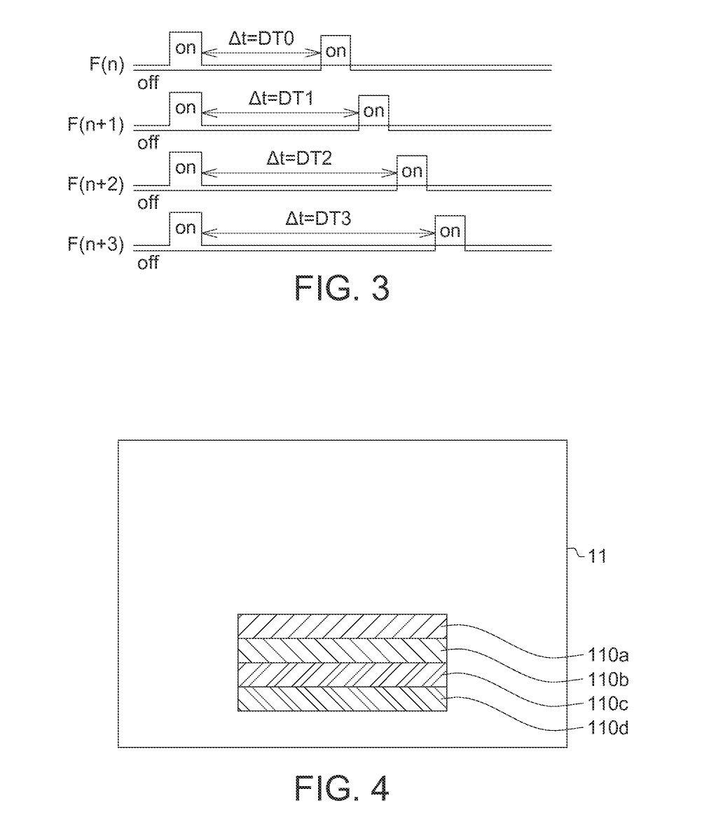

FIG. 3 shows a signal timing diagram of the main scan signal and the sub scan signal in different frame times according to the first embodiment of the present invention. FIG. 4 shows a linear residual image respectively displayed in four frame times according to the first embodiment. When a linear residual image is respectively displayed in four different frame times, the linear residual image is divided into four linear residual images with reduced brightness, such that sensitivity of human eyes towards such linear residual image with the reduce brightness is also lowered. In each frame time, the sub scan signal LCS is outputted at a delay time value ΔT after the main scan signal MS is outputted, and the frame times include at least two different delay time values. For illustration purposes, an example of four frame times and four delay time values are depicted in FIG. 3. The delay time Δt in frame times F(n) to F(n+3) respectively corresponds to delay time values DT0 to DT3. The delay time values DT0 to DT3 are different.

Referring to FIGS. 1, 3 and 4, for example, the delay time value Δt in the frame time F(n) equals the delay time value DT0, which is an activation time of five scan lines, for example. As the sub scan signal LCS and the main scan signal MS activate two rows of pixels at a time, at this point, the pixels activated by the sub scan signal LCS and the pixels activated by the main scan signal MS differ by a value of an activation time of 10 rows of scan lines. For example, when the second pixels 116 at the 24^{th} row of the LCD panel 11 are controlled by the main scan signal MS to be written with the second polarity data D− in the frame time F(n), the first pixels 115 at the 13^{th} row and the second pixels 116 at the 14^{th} row are controlled by the sub scan signal LCS to perform a charge distribution in the frame time F(n).

The delay time value Δt in the frame time F(n+1) equals the delay time value DT1, which an activation time of six scan lines, for example. As the sub scan signal LCS and the main scan signal MS activate two rows of pixels at a time, at this point, the pixels activated by the sub scan signal LOS and the pixels activated by the main scan signal MS differ by a value of an activation time of 12 rows of scan lines. For example, when the second pixels 116 at the 24^{th} row of the LCD panel 11 are controlled by the main scan signal MS to be written with the second polarity data D− in the frame time F(n+1), the first pixels 115 at the 11^{th} row and the second pixels 116 at the 12^{th} row are controlled by the sub scan signal LCS to perform a charge distribution in the frame time F(n+1).

The delay time value Δt in the frame time F(n+2) equals the delay time value DT2, which an activation time of seven scan lines, for example. As the sub scan signal LCS and the main scan signal MS activate two rows of pixels at a time, at this point, the pixels activated by the sub scan signal LCS and the pixels activated by the main scan signal MS differ by a value of an activation time of 14 rows of scan lines. For example, when the second pixels 116 at the 24^{th} row of the LCD panel 11 are controlled by the main scan signal MS to be written with the second polarity data D− in the frame time F(n+2), the first pixels 115 at the 9^{th} row and the second pixels 116 at the 10^{th} row are controlled by the sub scan signal LCS to perform a charge distribution in the frame time F(n+2).

Next, the delay time value Δt in the frame time F(n+3) equals the delay time value DT3, which a activation time of eight scan lines, for example. As the sub scan signal LCS and the main scan signal MS activate two rows of pixels at a time, at this point, the pixels activated by the sub scan signal LCS and the pixels activated by the main scan signal MS differ by a value of an activation time of 16 rows of scan lines. For example, when the second pixels 116 at the 24^{th} row of the LCD panel 11 are controlled by the main scan signal MS to be written with the second polarity data D− in the frame time F(n+3), the first pixels 115 at the 7^{th} row and the second pixels 116 at the 8^{th} row are controlled by the sub scan signal LCS to perform a charge distribution in the frame time F(n+3).

The noise voltage generated by data coupling writes different row pixels in different frame times. As such, the original single linear residual image is expanded into a linear residual image 110a, a linear residual image 110b, a linear residual image 110c and a linear residual image 110d. Since the brightness of the original single linear residual image is divided equal into four parts, the brightness of the residual images is relatively reduced so that human eyes may not perceive the existence of the residual images.

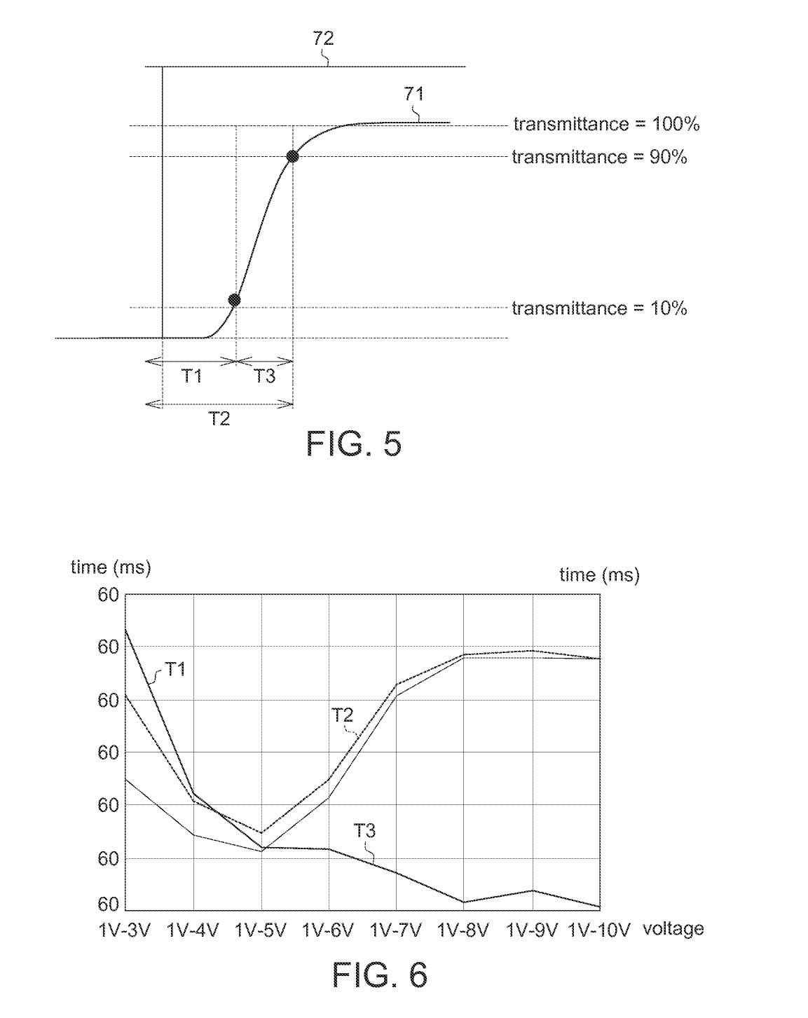

FIG. 5 is a schematic diagram of a transmittance change of liquid crystals after applying a voltage. Referring to FIGS. 1 and 5, the transmittance of the liquid crystals is as shown by a curve 71 when a voltage 72 is applied to the LCD panel 11. A liquid crystal delay time T1 represents a period that the transmittance of the liquid crystals changes from 0 to 10% after applying the voltage 72 to the LCD panel 11. A stable time T2 represents a period that the transmittance of the liquid crystals is between 10% and 90% after applying the voltage 72 to the LCD panel 11.

FIG. 6 shows a schematic diagram of the liquid crystal delay time T1, the stable time T2 and a rising time T3 for different voltage intervals. Table-1 below lists difference sizes of panels. The stable time T2 and the rising time T3 correspond to the vertical axis on the left, and the liquid crystal delay time T1 correspond to the vertical axis on the right. The liquid crystal delay time T1 can be calculated according to the stable time T2 and the rising time T3, The liquid crystal delay time T1 equals 3.2 ms when the voltage change interval is 1V to 6V, 2 ms when the voltage change interval is 1V to 7V, and 0.6 ms when the voltage change interval is 1V to 8V.

A liquid crystal delay time T1′ represents a period that the transmittance of the liquid crystals changes from 0 to 1%. The liquid crystal delay time T1′ equals 320 μm when the voltage change interval is 1V to 6V, 200 μm when the voltage change interval is 1V to 7V, and 60 μm when the voltage change interval is 1V to 8V.

When a frame rate of the LCD panel 11 is 120 Hz, an activation time of one scan line for resolutions 4K2K, FHD and HD is respectively 3.5 μm, 7 μm and 10 μm. When a frame rate of the LCD panel 11 is 60 Hz, an activation time of one scan line for resolutions 4K2K, FHD and HD is respectively 7 μm, 14 μm and 20 μm.

A maximum number of different delay time values is determined by 1% of the rising time of the LCD panel 11, i.e., the liquid crystal delay time T1′, For example, when the LCD panel 11 has a resolution of 4K2K and a frame rate f 120 Hz, the activation time of one scan line is approximately 3.5 μm. A quotient of 91 is obtained from dividing 320 μm by 3.5 μm, so that the maximum number of different delay time values is 91. In other words, the original single linear residual image may be expanded into a maximum of 91 linear residual images having reduced brightness.

TABLE 1

| | | | Upper limit of number of different delay | | | | | |
|---|---|---|---|---|---|---|---|---|
| Voltage | | | time values | | | | | |
| change | T1 | T1′ | 120 Hz | | | 60 Hz | | |
| interval | (ms) | (us) | 4K2K | FHD | HD | 4K2K | FHD | HD |
| 1 V~6 V | 3.2 | 320 | 91 | 45 | 32 | 45 | 22 | 16 |
| 1 V~7 V | 2 | 200 | 57 | 28 | 20 | 28 | 14 | 10 |
| 1 V~8 V | 0.6 | 60 | 17 | 8 | 6 | 8 | 4 | 3 |

### Second Embodiment

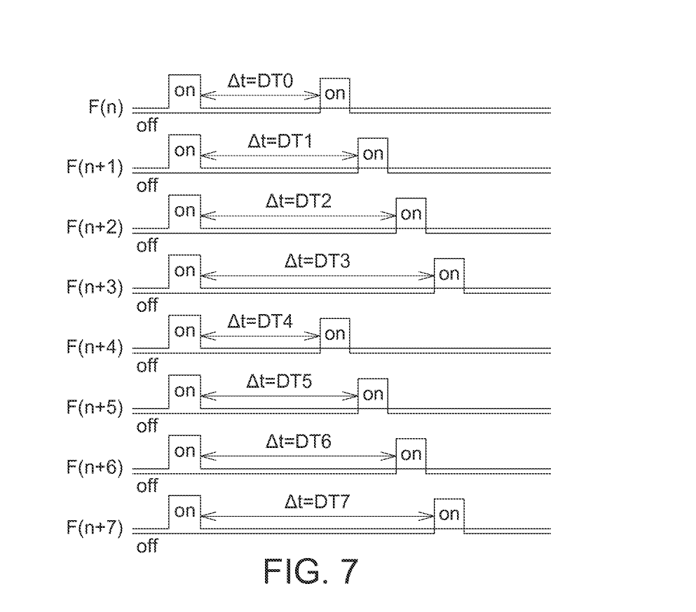

Referring to FIGS. 1 and 7, FIG. 7 shows a signal timing diagram of a main scan signal and a sub scan signal in different frame times according to a second embodiment of the present invention. A main difference of the second embodiment from the first embodiment is that, the timing controller 14 controls the gate driver to further output the sub scan signals LCS in frame times F(n+4) to F(n+7), and the sub scan signals LCS in the frame times F(n+4) to F(n+7) are respectively the same as the sub scan signals LCS in the frame times F(n) to F(n+3). The delay time value Δt in the frame times F(n+4) to F(n+7) corresponds to delay time values DT4 to DT7, respectively. The delay time values DT4 to DT7 are different, and respectively equal the delay time values DT0 to DT3.

### Third Embodiment

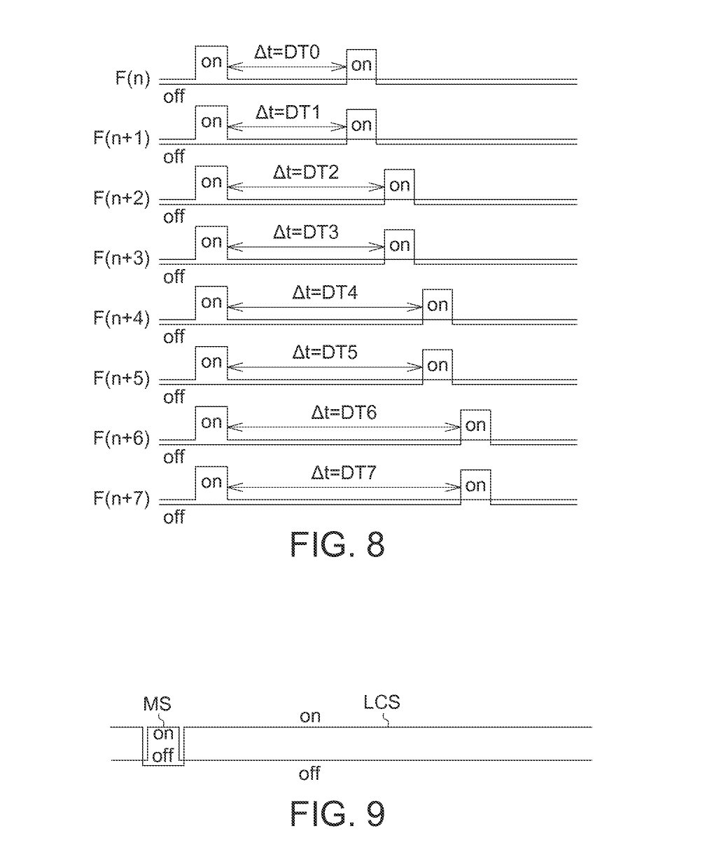

Referring to FIGS. 1 and 8, FIG. 8 shows a signal timing diagram of a main scan signal and a sub scan signal in different frame times according to a third embodiment of the present invention. A main difference of the third embodiment from the second embodiment is that, the delay time value Δt in the frame times F(n) to F(n+7) corresponds to delay time values DT0 to DT7, respectively. The delay time value DT0 equals the delay time value DT1, and the delay time value DT2 equals the delay time value DT3. The delay time value DT4 equals the delay time value DT5, and the delay time value DT6 equals the delay time DT7. The delay time values DT0, DT2, DT4 and DT6 are different from one another.

### Fourth Embodiment

Referring to FIGS. 1 and 9, FIG. 9 shows a signal timing diagram of a main scan signal and a sub scan signal in different frame times according to a fourth embodiment of the present invention. A main difference of the fourth embodiment from the first embodiment is that, a period that the sub scan signals LCS enable the sub scan lines 14 is greater than a period that the main scan signals MS enable the main scan lines 113. When the main scan signals MS disable the main scan lines 113, the sub scan signals LCS continue to enable the sub scan lines 114. In other words, the enable period of the sub scan lines 114 is greater than the disable period.

### Fifth Embodiment

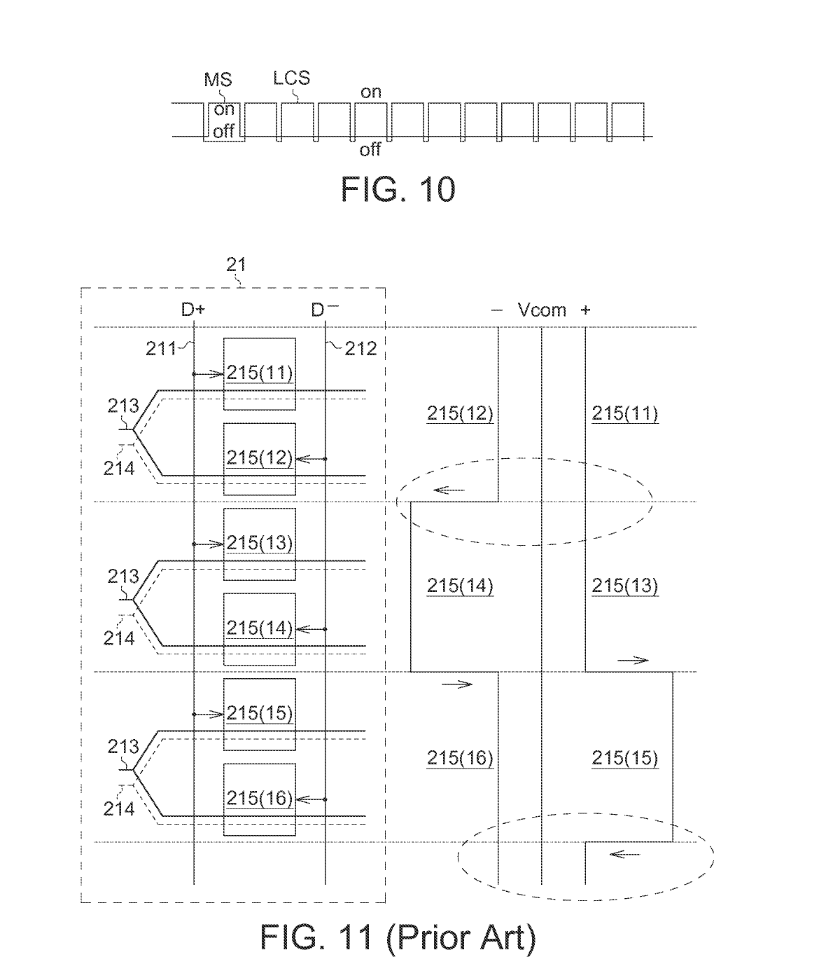

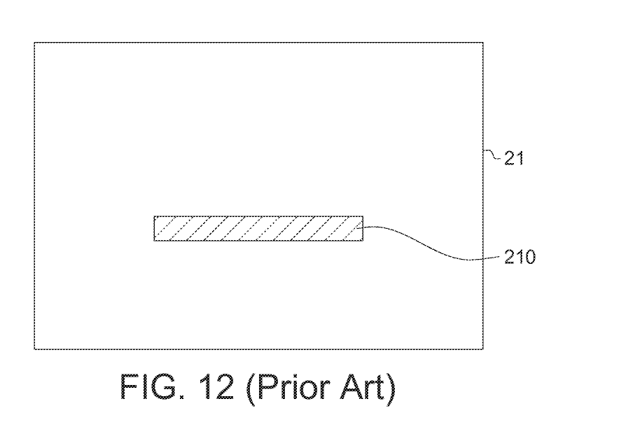

Referring to FIGS. 1 and 10, FIG. 10 shows a signal timing diagram of a main scan signal and a sub scan signal in different frame times according to a fifth embodiment of the present invention. A main difference of the fifth embodiment from the fourth embodiment is that, each sub scan signal in the fifth embodiment includes multiple consecutive scan pulses. As the number of scan pulses of the sub scan signals is greater than the number of scan pulses of the main scan signals, a period that the sub scan signals LCS enable the sub scan lines 114 is far greater than a period that the main scan signals MS enable the main scan lines 113.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display apparatus, comprising:
a liquid crystal display (LCD) panel, comprising:
a plurality of first polarity data lines;
a plurality of second polarity data lines;
a plurality of main scan lines;
a plurality of sub scan lines;
a plurality of first pixels, each coupled to the first polarity data line, the main scan line and the sub scan line; and
a plurality of second pixels, each coupled to the second polarity data line, the main scan line and the sub scan line;
a source driver, for outputting a plurality of first polarity data to corresponding the first polarity data lines, and a plurality of second polarity data to corresponding the second polarity data lines;
a gate driver, coupled to the main scan lines and the sub scan lines; and
a timing controller, for controlling the gate driver to alternately output a main scan signal and a sub scan signal in every frame time;
wherein, a time difference between the main scan signal and adjacent the sub scan signal is a delay time value; the main scan signal controls the first pixel to be written with the first polarity data and the second pixel to be written with the second polarity data,and the frame times comprise at least two different the delay time values.

2. The display apparatus according to claim 1, wherein the frame times comprises a first frame time and a second frame time; the delay time values comprise a first delay time value and a second delay time value; the first frame time and the second frame time respectively correspond to the first delay time value and the second delay time value; and the first delay time value and the second delay time value are different.

3. The display apparatus according to claim 2, wherein the frame times comprise a third frame time and a fourth frame time; the delay time values comprise a third delay time value and a fourth delay time value; the third frame time and the fourth frame time respectively correspond to the third delay time value and the fourth delay time value; and the first delay time value, the second delay time value, the third delay time value and the fourth delay time values are different.

4. The display apparatus according to claim 2, wherein the frame times comprise a third frame time and a fourth frame time; the delay time values comprise a third delay time value and a fourth delay time value; the third frame time and the fourth frame time respectively correspond to the third delay time value and the fourth delay time value; and the third delay time value and the first delay time value are equal, and the fourth delay time and the second delay time value are equal.

5. The display apparatus according to claim 1, wherein:
each of the first pixels comprises:
a first liquid crystal capacitor;
a first transistor, controlled by the main scan signal to electrically connect the first polarity data line to the first liquid crystal capacitor;
a second liquid crystal capacitor;
a second transistor, controlled by the main scan signal to electrically connect the first polarity data line to the second liquid crystal capacitor;
a first dark-area capacitor; and
a third transistor, controlled by the sub scan signal to electrically connect the first dark-area capacitor to the second liquid crystal capacitor; and
each of the second pixels comprises:
a third liquid crystal capacitor;
a fourth transistor, controlled by the main scan signal to electrically connect the second polarity data line to the third liquid crystal capacitor;
a fourth liquid crystal capacitor;
a fifth transistor, controlled by the main scan signal to electrically connect the second polarity data line to the fourth liquid crystal capacitor;
a second dark-area capacitor; and
a sixth transistor, controlled by the sub scan signal to electrically connect the second dark-area capacitor to the fourth liquid crystal capacitor.

6. The display apparatus according to claim 1, wherein the timing controller adjusts the delay time values according to a frame number.

7. The display apparatus according to claim 1, wherein a maximum number of the delay time values is determined by 1% of a rising time of the LCD panel.

8. The display apparatus according to claim 7, wherein the rising time is a period that transmittance of liquid crystal molecules changes from 0 to 10% after applying a voltage to the liquid crystal molecules.

9. A display apparatus, comprising:
a LCD panel, comprising:
a plurality of first polarity data lines;
a plurality of second polarity data lines;
a plurality of main scan lines;
a plurality of sub scan lines;
a plurality of first pixels, each coupled to the first polarity data line, the main scan line and the sub scan line; and
a plurality of second pixels, each coupled to the second polarity data line, the main scan line and the sub scan line;
a source driver, for outputting a plurality of first polarity data to corresponding the first polarity data lines, and a plurality of second polarity data to corresponding the second polarity data lines;
a gate driver, coupled to the main scan lines and the sub scan lines; and
a timing controller, for controlling the gate driver to alternately output a main scan signal and a sub scan signal in every frame time;
wherein, a time difference between the main scan signal and adjacent the sub scan signal is a delay time value; the main scan signal controls the first pixel to be written with the first polarity data and the second pixel to be written with the second polarity data and a period that the sub scan signal enables the sub scan line is greater than a period that the main scan signal enables the main scan line.

10. The display apparatus according to claim 9, wherein the sub scan signal enables the sub scan line when the main scan signal disables the main scan line, and the sub scan signal comprises a plurality of scan pulses.
